(19) United States
(12) Patent Application Publication
(10) Pub. No.: US 2003/0056071 A1
(43) Pub. Date: Mar. 20, 2003

(54) Adaptable boot loader

(76) Inventors: Joseph W. Triece, Phoenix, AZ (US); Timothy J. Phoenix, Peperell, MA (US)

Correspondence Address: BAKER BOTTS, LLP, 910 LOUISIANA, HOUSTON, TX, 77002-4995, US

(21) Appl. No.: 09/955,328

(22) Filed: Sep. 18, 2001

(51) Int. Cl. G06F 12/00

(52) U.S. Cl. 711/165; 713/2

(57) ABSTRACT

A microcontroller, which addresses program memory separately from data memory, is disclosed. The microcontroller includes a CPU and a boot memory coupled to the CPU. A control is coupled to the CPU and to the boot memory. In a first state, the control causes the boot memory to be configured as data memory. In a second state, the control causes the boot memory to be configured as program memory. A method for loading the boot memory is also disclosed. The method includes configuring the boot memory to be addressed as data memory unless it is already configured to be addressed as data memory, loading a program from an external program memory into the boot memory, configuring the boot memory to be addressed as a program memory, and executing the program in the boot memory. A method for using the microcontroller and method to debug software is described.

### FIELD OF THE INVENTION

The present invention relates generally to microcontrollers, and more particularly to adaptable bootloaders for microcontrollers.

### BACKGROUND OF THE INVENTION TECHNOLOGY

For microcontrollers that have the capability to execute commands from off-chip (“external”) program memory, it is desirable to have the ability to perform in-system program modification of external memory. To accomplish this, some program code must be configured onboard the microcontroller in order to execute an external program memory loader routine. Such onboard program code is sometimes referred to as a “bootloader,” because it is usually executed when the device “boots” up out of reset.

Some microcontrollers that have an external bus interface have a small onboard ROM program memory customized to perform programming of external memory. The program stored in the on-board ROM typically is customized by the microcontroller manufacturer for each customer's application. A ROMless microcontroller does not contain an onboard program ROM or FLASH memory.

Most external memories that can be modified, such as flash memory or RAM, can be addressed with a traditional address and data bus. Some external devices (such as serial memories, input/output devices, etc.) require unique programming algorithms that cannot be performed using traditional address and data busses.

A way to provide an adaptable bootloader, for example to modify external memory, or another type of adaptable program in an onboard memory in a ROMless microcontroller is needed.

### SUMMARY OF THE INVENTION

The invention overcomes the above-identified problems as well as other shortcomings and deficiencies of existing technologies by providing an onboard boot memory that can function as either program memory or as data memory. The boot memory is loaded with a program when it is configured as data memory. The boot memory is then converted to program memory and the program it stores is executed.

In accordance with an exemplary embodiment of the present invention, the invention features a microcontroller, which addresses program memory separately from data memory. The microcontroller includes a CPU and a boot memory coupled to the CPU. A control is coupled to the CPU and to the boot memory. In a first state, the control causes the boot memory to be configured as data memory. In a second state, the control causes the boot memory to be configured as program memory.

Implementations of the invention may include one or more of the following. The control may include a memory control register. The memory control register may include a program enable flag. When it has a first value, the program enable flag may cause the control to be in the first state. When it has a second value, the program enable flag may cause the control to be in the second state. The microcontroller may include an external port coupled to the CPU and to the control. The external port may be configured as a system bus when (1) the control is in the first state, and (2) the control is in the second state and the CPU is accessing external memory as data memory. The external port may be configured as an input/output port when the control is in the second state and the CPU is not accessing the external memory as program or data memory. The external port is configured as a system bus when the boot memory is addressed as data memory. The external port may be configured as an input/output port when the boot memory is addressed as program memory. The external port is configured as a system bus when the boot memory is addressed as data memory and when the CPU writes to an external memory via the external port using an instruction that allows writes to program memory, and otherwise, the external port may be configured as an input/output port.

In general, in another aspect, the invention features a microcontroller, which addresses program memory separately from data memory. The microcontroller includes a control, having a first state and a second state, a boot memory coupled to the control, and an external port coupled to the control. The external port is configured as a system bus when (1) the control is in the first state and the boot memory is not addressed, or (2) the control is in the second state and the external port is used to address an external memory as data memory. The external port is configured as an input/output port when the control is in the second state, the boot memory is addressed, and the external port is not used to address the external memory as program or data memory.

Implementations of the invention may include one or more of the following. The boot memory may be configured as data memory if the port control is in the first state and as program memory if the port control is in the second state. The external port may be configured as a system bus when the CPU writes to an external memory via the external port using an instruction that allows writes to program memory.

In general, in another aspect, the invention features a method for loading a boot memory onboard a microcontroller. The microcontroller addresses program memory separately from data memory. The method includes configuring the boot memory to be addressed as data memory unless it is already configured to be addressed as data memory, loading a program from an external program memory into the boot memory, configuring the boot memory to be addressed as a program memory, and executing the program in the boot memory.

Implementations of the invention may include one or more of the following. Loading the program from the external program memory into the boot memory may include moving a word of the program from external program memory into a working register by directly addressing the working register, and moving the word from the working register to a boot memory location by directly addressing the boot memory location as a register. The boot memory may be divided into banks and the boot memory may be addressable using offset addressing within the banks. Loading the program from the external program memory into the boot memory may include moving a word of the program from external program memory into a working register by directly addressing the working register, and moving the word from the working register to the boot memory by offset addressing the boot memory. Configuring the boot memory to be addressed as data memory may include setting the state of a control flag. Setting the state of the control flag may include setting a bit in a memory control register.

In general, in another aspect, the invention features an apparatus for booting a microcontroller, which addresses program memory separately from data memory, by loading a program from an external program memory into a boot memory on the microcontroller. The apparatus includes a control coupled to the boot memory, which in a first state causes the microcontroller to address the boot memory as data memory, and in a second state causes the microcontroller to address the boot memory as program memory. The apparatus also includes a first program stored in the external program memory which causes the microcontroller to switch the control to the first state, transfer a second program from the external program memory to the boot memory, switch the control to the second state, and execute the second program in the boot memory.

Implementations of the invention may include one or more of the following. The apparatus may include an external port coupled to the control, which operates as a system bus when (1) the control is in the first state, or (2) the control is in the second state and the CPU is accessing the external program memory as data memory, and which operates as an input/output port when the control is in the second state and the CPU is not accessing the external program memory as program and/or data memory. The first program may cause the microcontroller to transfer the second program from the external program memory to the boot memory via the external port. The second program may cause the microcontroller to use the external port as an input/output port and as a system bus.

In general, in another aspect, the invention features a method for using a microcontroller, which addresses program memory separately from data memory and which includes a boot memory, to debug software stored in an external memory. The method includes repeating the following until the debug process is complete: loading communication software into the boot memory, loading a bootloader into the boot memory, executing the communication software and the bootloader, modifying the software stored in the external memory through the communications software and the bootloader, loading debug software into the boot memory, executing the debug software and the communication software, executing the software stored in the external memory, and stopping execution of the software stored in the external memory.

Implementations of the invention may include one or more of the following. Loading communication software into the boot memory may include converting the boot memory so that it is addressed by the microcontroller as data memory unless the boot memory is already addressed as data memory, loading the communication software into the boot memory, and converting the boot memory so that it is addressed by the microcontroller as program memory.

In general, in another aspect, the invention features a microcontroller, which includes a CPU, program address and data busses coupled to the CPU, data address and data busses coupled to the CPU, input/output busses coupled to the CPU, and an onboard RAM comprising a boot RAM. The microcontroller further includes a memory selector, coupled to the program address and data busses, the data address and data busses and the boot RAM, which can be actuated to select whether the boot RAM is addressed by the program address and data busses or the data address and data busses. The microcontroller further includes an external interface and an output port selector, coupled to the program address and data busses, the input/output busses and the external interface, which can be actuated to select the program address and data busses or the input/output busses to couple to the external interface. The microcontroller further includes a memory control coupled to the CPU for actuating the memory selector, and an output port control coupled to the CPU for actuating the output port selector.

A technical advantage of the present invention is that external memory can be adaptively modified without the need for a customized onboard ROM. Another technical advantage is that an onboard memory space can be used as either data memory or program memory. Still another technical advantage is that the entire range of external memory can be modified by a program running from the internal memory.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a block diagram of a portion of a microcontroller.

FIG. 2 is a map of program memory when the boot memory is configured as data memory.

FIG. 3 is a map of program memory when the boot memory is configured as program memory.

FIG. 4 is a map of memory internal to the microcontroller when the boot memory is configured as data memory.

FIG. 5 is a map of memory internal to the microcontroller when the boot memory is configured as program memory.

FIG. 6 illustrates copying a bootloader from external memory to the boot memory.

FIG. 7 illustrates the bootloader executing in boot memory.

FIG. 8 illustrates the mechanics of copying the bootloader from the external memory to the boot memory.

FIG. 9 illustrates the mechanics of executing the bootloader on reset.

FIG. 10 illustrates the microcontroller in a debug configuration.

FIG. 11 is a flow chart of the debug operation.

FIG. 12 illustrates the mechanics of copying the debug code from the external memory to the boot memory.

FIG. 13 illustrates the mechanics of executing the debug code on reset.

FIG. 14 is a flow chart of storing and executing a program in boot memory.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to an adaptable bootloader for a microcontroller.

Referring now to the drawings, the details of an exemplary embodiment of the present invention is schematically illustrated. Like elements in the drawings will be represented by like numbers, and similar elements will be represented by like numbers with a different lower case letter suffix.

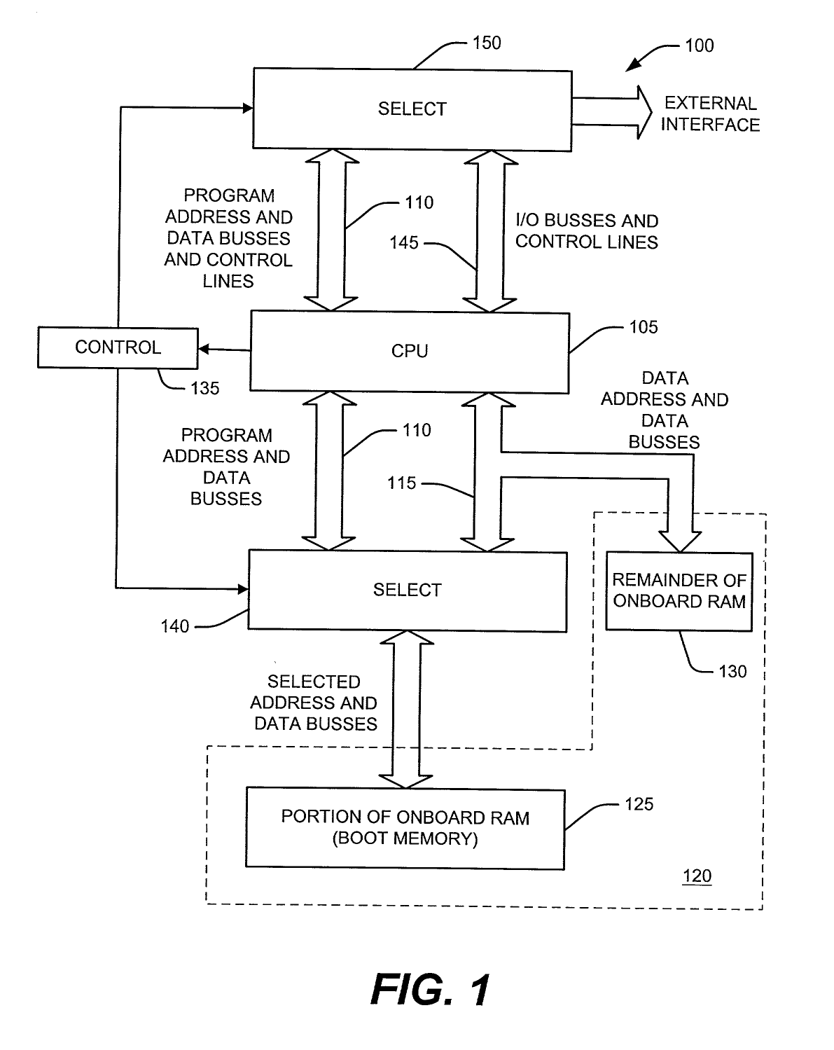

In the exemplary embodiment depicted in FIG. 1, a microcontroller 100 includes a central processing unit (CPU) 105, which has “program” address and data busses 110 and “data” address and data busses 115. Note that FIG. 1 depicts only a portion of the elements of the microcontroller 100. The program busses 110 are used to access a “program” memory and the data busses 115 are used to access “data” memory that is separate from the program memory. An example of such an architecture, called a “Harvard architecture,” is described in detail in co-pending and co-owned U.S. patent application Ser. No. 09/280,112, filed on Mar. 26, 1999 and entitled MICROCONTROLLER INSTRUCTION SET, incorporated by reference. The Harvard architecture improves bandwidth over the traditional von Neumann architecture, in which program memory and data memory are accessed over the same address and data busses.

The microcontroller 100 includes an onboard random access memory (RAM) 120. A portion 125 of the onboard RAM 120 can be addressed as either program memory or data memory. The onboard RAM portion 125 will be referred to hereafter as the “boot memory.” The remainder 130 of the onboard RAM 120 is always addressed as data memory.

The CPU 105 controls whether the boot memory 125 is addressed as data memory or program memory through control 135, which causes a select function 140 to select either the program busses 110 or the data busses 115 to present to the boot memory 125.

The CPU 105 also includes input/output (I/O) busses and control lines 145. When the boot memory 125 is configured as data memory, the program driving the CPU 105 is typically stored in external memory, which is an off-chip memory external to the microcontroller 100. In that case, the program busses and associated control lines 110 are presented externally to allow the CPU 105 to access and control the external memory. When the boot memory 125 is configured as program memory and the CPU 105 is executing code stored in the boot memory 125, the program busses and associated control lines 110 do not have to be presented externally even so they could. If they are presented externally, they are held in an inactive state. Otherwise, the I/O busses and control lines 145 are presented externally using the same ports otherwise used for the program busses 110.

A select function 150, which is driven by the same control 135 that selects whether the boot memory is program memory or data memory, determines whether the program busses and control lines 110 or the I/O busses and control lines are presented externally. The select function 150 may switch the I/O busses to the external interface whenever the control indicates that the boot memory 125 is configured as program memory. Preferably, it may make that switch only when the boot memory 125 is actually accessed as program memory. In this case the external bus has only I/O functionality. If the CPU accesses an external memory as data memory, for example for the TBLRD or TBLWR instructions, the select function 150 switches the program busses and control lines 110 to the external interface, even if the boot memory is being accessed as program memory.

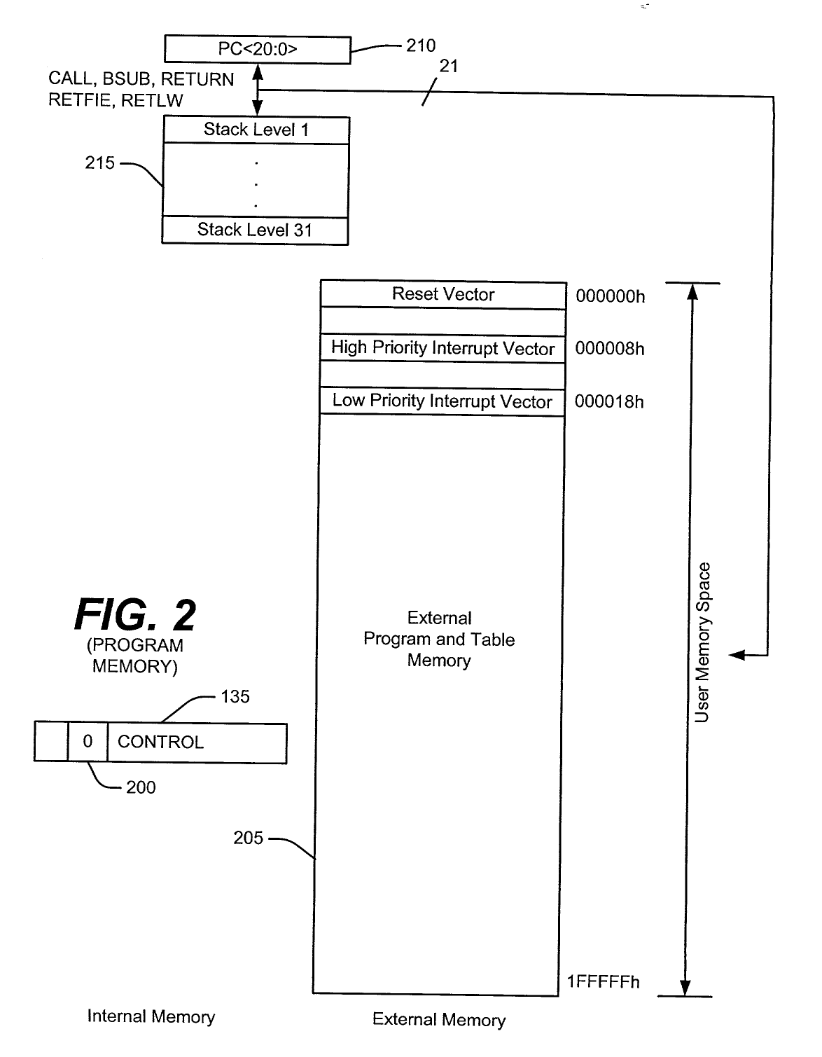

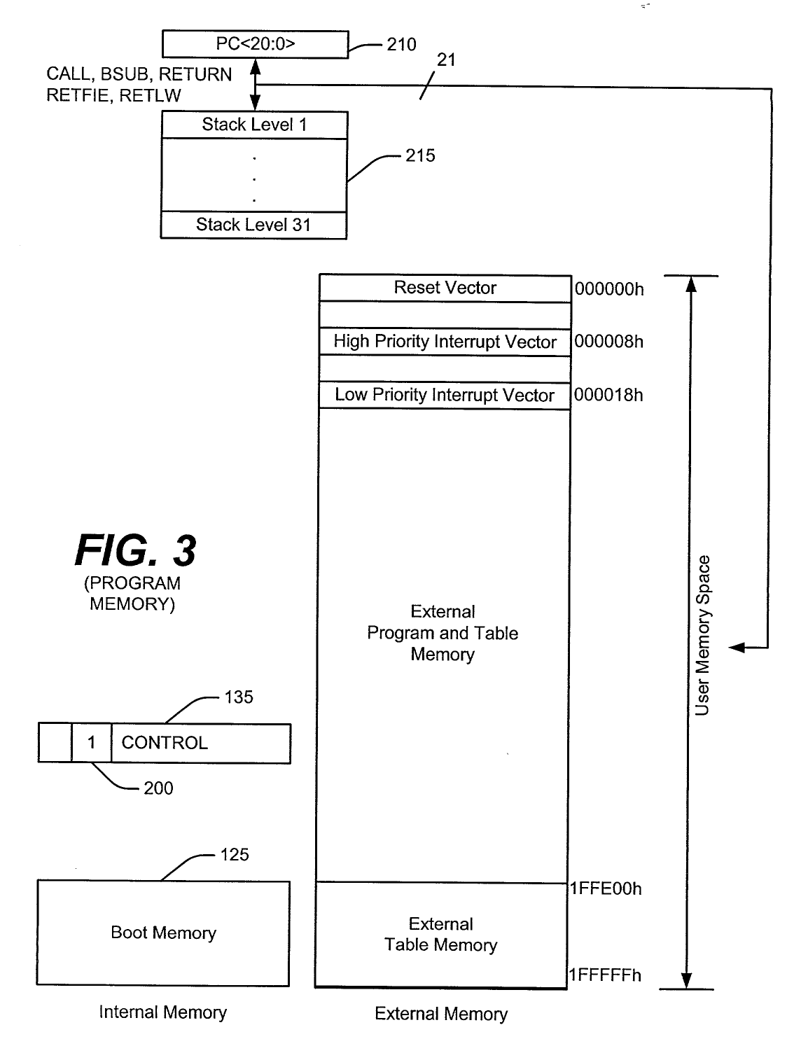

A map of the program memory, illustrated in FIGS. 2 and 3, changes depending on the state of the control 135. In one example implementation, the control includes a memory control register, MEMCON. One MEMCON bit 200, the PGRM bit, determines the state of the control 135 at least as it relates to the select function 140. If the PGRM bit is “0,” the boot memory 125 is configured to be data memory. If the PGRM bit is “1,” the boot memory 125 is configured to be program memory. The PGRM bit may also determine the state of the control 135 as it relates to the select function 150.

Alternatively, the select function 150 may be controlled by another mechanism, such as by another bit in the MEMCON register, a bit in another register, or another mechanism entirely. Preferably, the select function 150 is controlled by an EBDIS bit in the MEMCON register and the address being executed. If the EBDIS bit is set and the address being executed is in the boot memory, then the select function 150 will select the I/O busses and control lines 145 to present to the external interface. Otherwise, the select function 150 will select the program address and data busses and control lines 110 to present to the external interface. When the boot memory is accessed for program execution, it is assumed that TBLRD and TBLWT instructions, which allow reads and writes, respectively, from and to program memory, will be performed on external memory, because the program running from the boot memory is intended to be a bootloader. For those instructions, the EBDIS bit is not used when a TBLWT or TBLRD is executed and the select function 150 presents the program address and data and control lines 110 to the external interface.

FIG. 2 shows an example program memory map when the PGRM bit is “0” which causes the boot memory 125 to be configured to be data memory. In this case, the entire program memory space, which extends from 000000h to 1FFFFFh, is in external memory. Reset, high priority interrupt and low priority interrupt vectors are located at 000000h, 000008h, and 000018h, respectively.

The memory map includes a program counter 210 and a stack 215. A variety of opcodes (CALL, BSUB, RETURN, RETFIE, and RETLW), which cause data to be stored in or retrieved from the program counter 210 or the stack 215, are illustrated in FIG. 2.

The program memory map when the PGRM bit 200 is “1” which causes the boot memory 125 to be configured to be program memory, illustrated in FIG. 3, is the same as that shown in FIG. 2, except that the external memory from 1FFE00h to 1FFFFFh is no longer available as program memory. Instead, that range of program memory addresses now addresses the boot memory 125, which is onboard to the microcontroller 100.

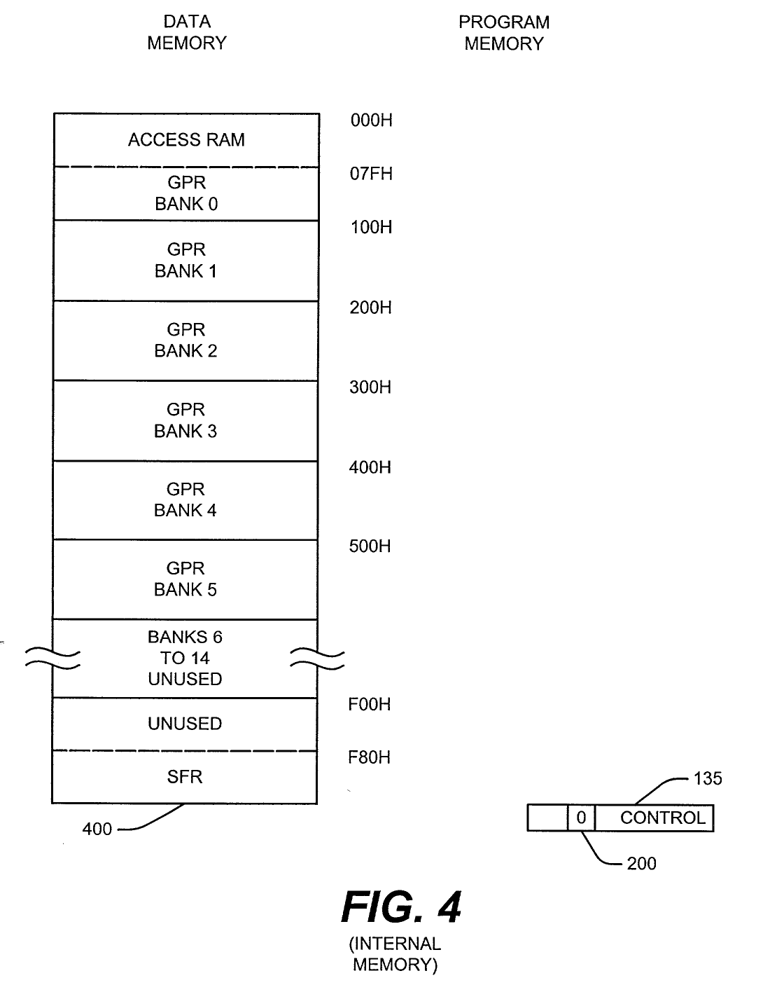

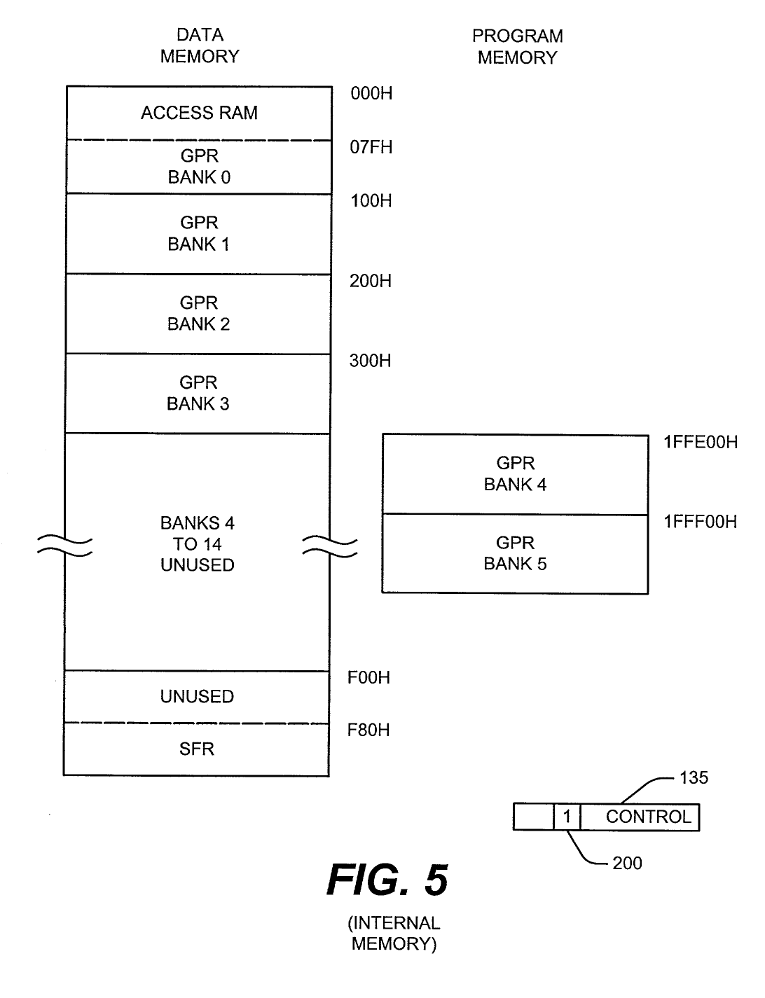

A map of the onboard RAM (also called “internal” memory), illustrated in FIGS. 4 and 5, also changes depending on the status of the PGRM bit 200. When the PGRM bit 200 is “0,” as in the example shown in FIG. 4, the internal memory 400 extends from 000h to FFFh. Internal memory 400 is divided into banks, each containing 100h memory locations. Any location in the internal memory 400 may be directly addressed or memory locations may be addressed by selecting a bank and specifying an offset within the bank.

In the example shown in FIG. 4, bank 0 is split into an Access RAM from 000h to 07Fh and a general purpose register (GPR) from 080h to 0FFh. Similarly, bank 15 is divided into an unused portion from F00h to F7Fh and a special function register (SFR) area from F80h to FFFh. In the example shown in FIG. 4, banks 6 to 14 are unused.

The split in banks 0 and 15 enables the concept of an “access bank.” The access bank is composed of two RAM partitions, access RAM high and access RAM low. Access RAM high is the SFR region mapped in bank 15 and access RAM low is the RAM that is banked in bank 0. A bit in the instruction word, referred to as the “a” bit, specifies if the operation is to occur in one of banks 0-15 (known as the BSR registers) or in the access bank. When the access bank is addressed, the last address in RAM low is followed by the first address in RAM high.

When the PGRM bit is set to “1,” the internal memory map changes to that shown in FIG. 5. The only difference is that banks 4 and 5 (which is the “boot memory” shown in FIG. 1), which had data memory addresses ranging from 400h to 5FFh in FIG. 4, now have program memory address ranging from 1FE00h to 1FFFFh.

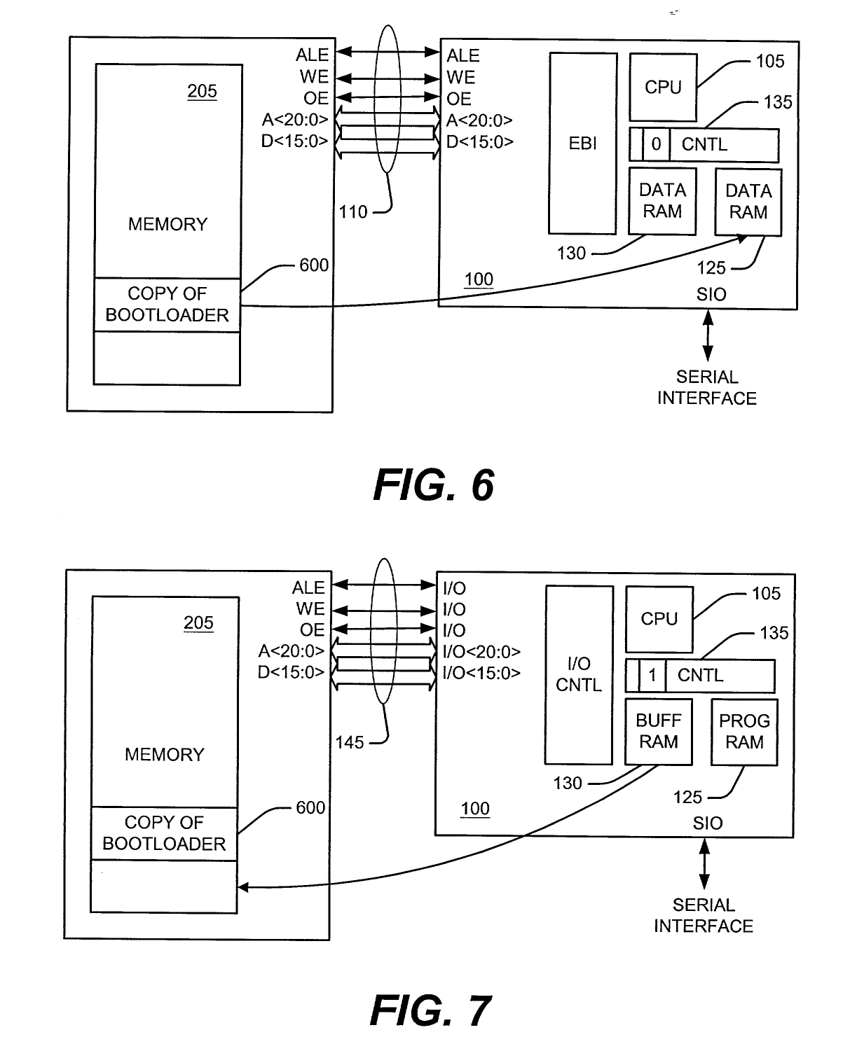

This capability of configuring the boot memory as either data memory or program memory allows a bootloader 600 to be copied from an external memory 205 into the boot memory 125 when it is configured as a data memory, as shown in FIG. 6. The boot memory 125 can then be converted into program memory and the bootloader can be executed from the boot memory 125, as shown in FIG. 7. FIGS. 6 and 7 also illustrate the transformation of the program busses and control lines 110 to I/O busses and control lines 145. The microcontroller 100 can modify external memory using the I/O busses and control lines 145 and data stored in the data RAM 130, as shown in FIG. 7. Further, the microcontroller can alter external memory using the TBLWT instruction, as discussed above.

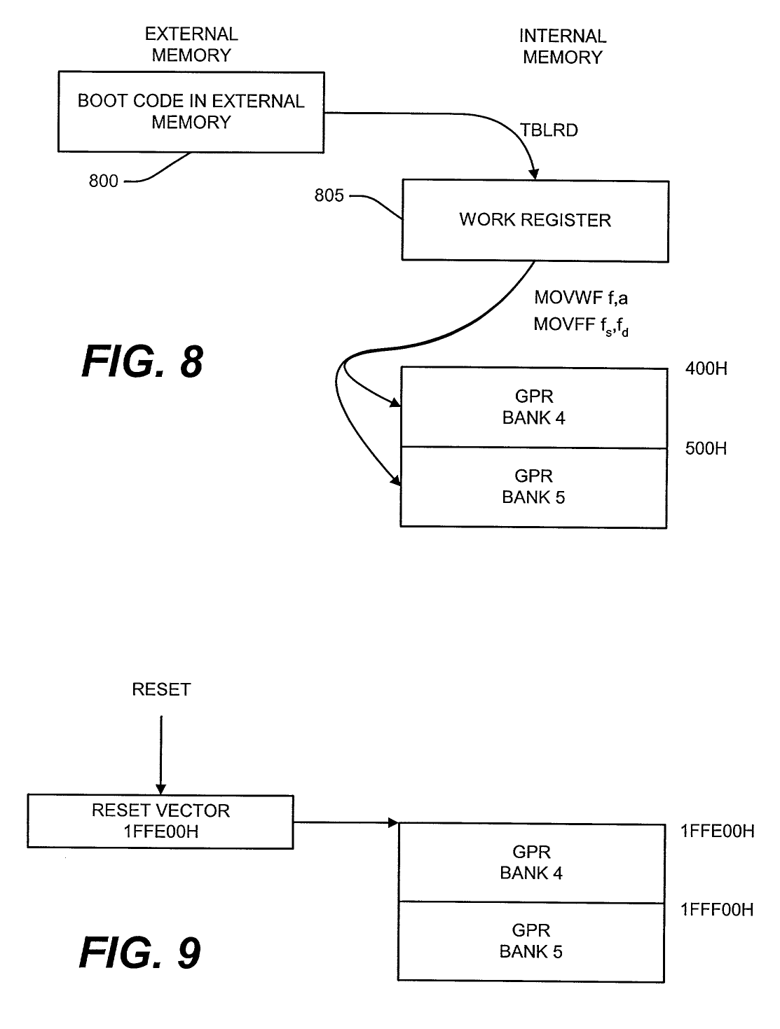

An example of the mechanics of moving data from the external memory into the boot memory when the boot memory is configured as data memory, is illustrated in FIG. 8. The instructions to move data from the external memory to the boot memory are executed from the external memory. A TBLRD instruction is executed using a location in external memory which contains the boot code 800 as the source address and the Work Register (or W register) 805 as the destination address. The TBLRD instruction has the ability to read data from program memory, as discussed above. In the example shown, the TBLRD instruction automatically increments the source address when it is executed. Consequently, over a series of TBLRD instructions, the entire bootloader is transferred, one byte at a time, into the Work Register.

After each byte is transferred, the program transfers the byte from the Work Register into banks 4 and 5 of the data memory. The program uses the MOVWF f,a function, which transfers data from the Work Register into an onboard register having the address “f.” The address “f” is incremented between each transfer. Alternatively, the program may use the MOVFF fₛ,f_{d} function, which transfers data from the onboard register fₛ to the onboard register f_{d}. In the example shown in FIG. 8, the address of register fₛ is set to be the address of the Work Register and the address of register f_{d} is incremented through the banks 4 and 5 of the data memory. These functions make use of a feature of the microcontroller that all of the onboard registers are directly addressable.

If the boot memory were only configurable as program memory, the write to boot memory would require a TBLPTR instruction, which allows a write to program memory. This would mean that the TBLPTR, which is the pointer that determines the source or destination address of a TBLRD or TBLWT, respectively, would have to be updated between each table operation. Configuring boot memory as data memory allows the use of the MOVWF and MOVFF instructions, which do not have the same limitation.

Once the bootloader has been transferred into the onboard data memory, the code accomplishing that task jumps to the beginning of the bootloader program and begins execution. Alternatively as illustrated in FIG. 8, the location of the beginning of blocks 4 and 5 of the onboard data memory when they are addressed as program memory, 1FFE00h, is stored in the reset vector 000000h, as shown in FIG. 9, and the microcontroller 100 is reset. The microcontroller 100 vectors to the reset vector and then to the bootloader program stored in banks 4 and 5 (boot memory).

The bootloader program executing from the boot memory provides the ability to modify any location in external memory. The external program memory can be mapped such that executing a TBLWT instruction to a memory location occupied by internal program memory can take place externally. This means that external program memory can occupy the entire address range, and that all of the external memory can be programmed by the bootloader executing from boot memory. This also prevents the bootloader from modifying itself while executing, which could be catastrophic.

Using this technique, a bootloader program 600 stored in external memory 205 can be transferred to the onboard boot memory 125 configured as data memory. The boot memory 125 can then be reconfigured as program memory and the bootloader program can be executed. Part of the bootloader program can be used to modify the data or programs stored in the external memory 205.

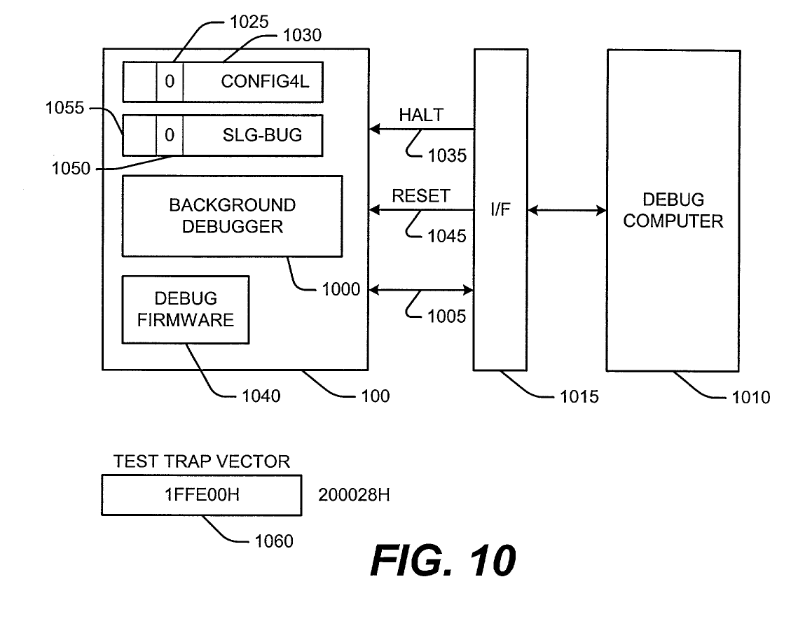

Another application for the circuit illustrated in FIG. 1 is to facilitate background debugging, as illustrated in FIG. 10. A background debugger can be used to debug software stored in the external memory 205. The background debugger can be configured to step through the software one instruction at a time, which allows a user to observe the results of each program step. The background debugger can also be configured to stop execution of the program when it reaches a particular point (a TRAP) or when a user stops its execution. Such a debugger typically provides the capability of modifying the program code being debugged to attempt to solve a problem identified during the debugging. To perform these functions, an example background debugger 1000 provides the following features: break on program fetch from a specific location; break on a (HALT) signal from the debug computer; break on execution of a TRAP instruction; break on next debug computer instruction execution, which provides a single step capability; and the ability to load and verify code.

In one example of an implementation of a background debugger, illustrated in FIG. 10, a software or hardware communication protocol 1005 is established between the microcontroller 100, which runs a background debugger 1000, and a debug computer 1010 through a debug interface 1015. The debug computer 1015, runs an evaluation tool which displays information provided by the background debugger and provides controls for the background debugger 1000.

A configuration bit (BKBUG) 1025 in a CONFIG4L register 1030 determines whether the background debugger 1000 is enabled. In this example, when BKBUG is set to “0,” the background debugger is enabled. In the debug-enabled configuration, the microcontroller 100 is responsive to a HALT signal 1035 and to the execution of TRAP instructions. Other functions of the microcontroller 100 are disabled to prevent the background debugger 1000 from corrupting certain registers.

In this example, when the BKBUG bit 1025 is set to “0,” the boot memory 125 is configured as program memory and can be used by debugger firmware 1040. When the BKBUG bit is set to “0”, the value of the PGRM bit 200 in the control register 135 (see FIGS. 2-7) has no effect on whether the boot memory 125 is configured as program memory or data memory.

In one example implementation, the user (i.e., the person using the debug computer 1010) will have a maximum of 1 k bytes of RAM 120 onboard the microcontroller 100 to store an application. The remaining 512 bytes (256 words) of onboard RAM 120 may be used to store the onboard debugger software.

In this example, in the debug environment, the microcontroller RESET signal 1045 can be activated by the debug computer 1010 or by other resources in a system that incorporates the microcontroller 100. When the BKBUG configuration bit is set to “0”, a RESET will vector the microcontroller 100 to a location determined by the state of a RSBUG bit 1050 in a SLG-BUG register 1055. In this example, when RSBUG=0 RESET will vector to code at address 000000h.

When RSBUG=1, RESET will vector to test trap vector location 1060 at address 200028h, which contains the address of the beginning of the background debugger code stored in the boot memory at address 1FFE00h. In one example implementation, the vector stored at location 200028h is encoded in hardware. The microcontroller 100 will vector to 1FFE00h and begin executing the debug software stored at that location.

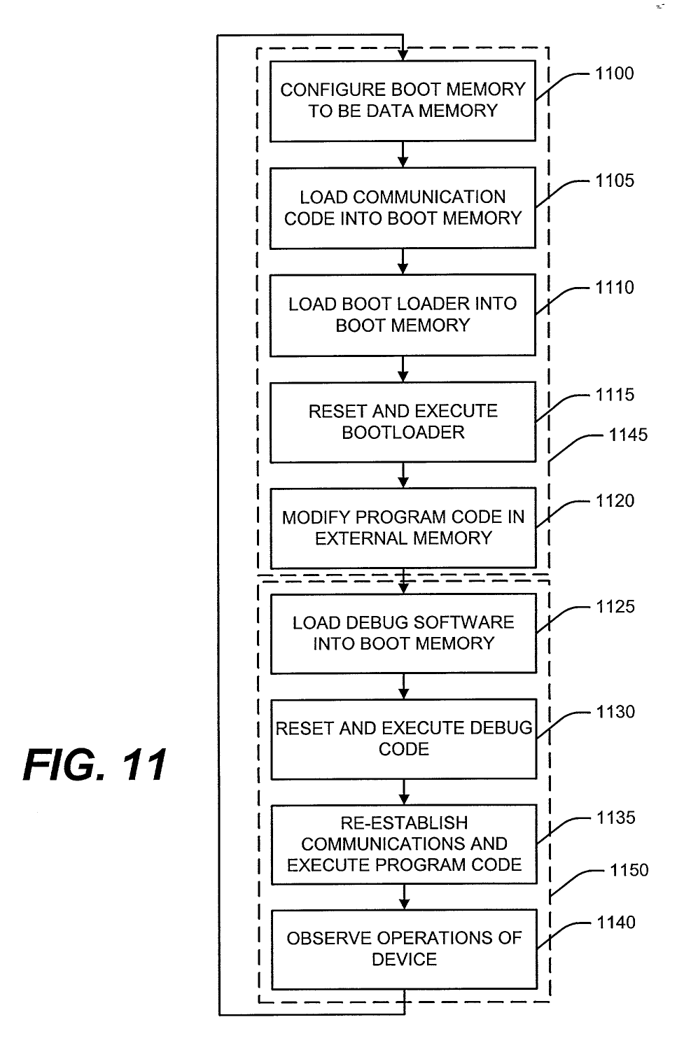

In one example implementation, external memory 205, which, for example, contains the program code being debugged, cannot be modified directly by the debug computer 1010. Therefore, if modifications are required to external memory during debugging, they will be performed through the boot memory 125. To accomplish this, the following steps, illustrated in FIG. 11, are performed (the following steps assume that the user wants to modify the program code in external memory and then debug the code):

1. The microcontroller 100 is placed into a mode in which the boot memory 125 can be loaded from the debug computer 1020 (block 1100). In one example embodiment, this is accomplished by asserting a high voltage on a MCLR input to the microcontroller 100 and configuring an RB6 pin and an RB7 pin to force the microcontroller 100 into a test mode. In the test mode, additional onboard memory addresses, such as the test trap vector 1060, are accessible by the microcontroller 100.

2. Communication code, which will allows communication between the microcontroller 100 and the debug computer 1010, is loaded into the boot memory 125 (block 1105).

3. Using the communication code, a custom bootloader provided by the debug computer 1020 is loaded into the boot memory 125 (block 1110).

4. The microcontroller 100 is RESET causing it to vector to and execute the custom bootloader (block 1115).

5. The user can then modify the program code stored in external memory using the communication code and the custom bootloader (block 1120).

6. Once external memory has been programmed, the debug computer 1010 loads the debug software into the boot memory 125 (block 1125).

7. The microcontroller is then RESET and the microcontroller vectors to and executes the debug software (block 1130).

8. The debug software re-establishes serial communications with the debug computer 1010 and then vectors to the code stored in the external memory (block 1135).

9. The debug computer 1010 can use the debug commands to control and observe the operation of the device controlled by the microcontroller (block 1140). An external break (HALT), or an internal breakpoint will vector the microcontroller 100 back to the debugger stored in the boot memory.

The cycle of (a) storing a bootloader in the boot memory 125 to allow the debug computer to program external memory (block 1145) followed by (b) storing debug software in the boot memory 125 to allow execution of the program stored in program memory (block 1150) continues until the user of the debug computer decides to stop debugging, sets the BKBUG bit to “1,” and RESETS the microcontroller 100.

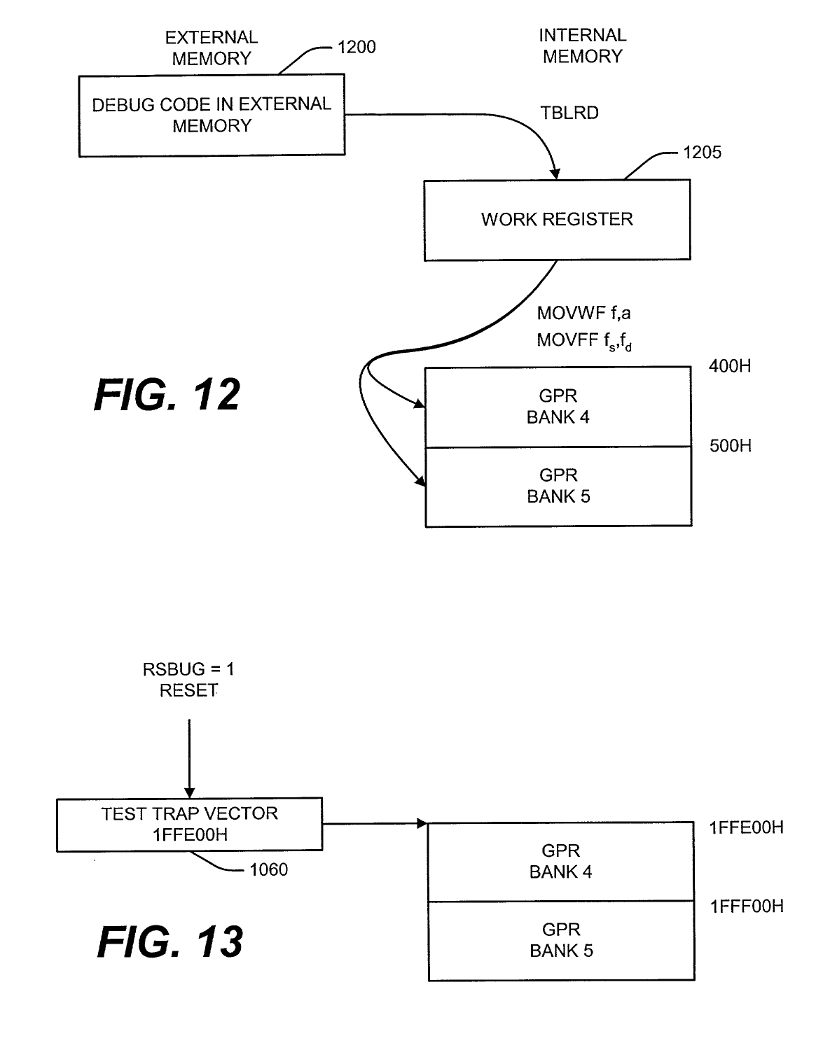

The mechanics of moving the debug code stored in external memory from external memory into the boot memory, illustrated in FIG. 12, are very similar to the mechanics discussed with respect to FIG. 8. A TBLRD instruction is executed using a location containing the debug code 1200 in external memory as the source address and the Work Register 1205 as the destination address. As before, the TBLRD instruction automatically increments the source address when it is executed. Consequently, over a series of TBLRD instructions, the entire debug code is transferred, one byte at a time, into the Work Register.

In the next step, the program transfers each instruction from the Work Register into banks 4 and 5 of the data memory. The program uses the MOVWF f,a function, which transfers data from the Work Register into a register having the address “f.” The address “f” is incremented between each transfer. Alternatively, the program may use the MOVFF fₛ,f_{d}, which transfers data from the register fₛ to the register f_{d}. In the example shown in FIG. 12, the address of the register fₛ is set to be the address of the Work Register and the address of f_{d} is incremented through the banks 4 and 5 of the data memory (the boot memory 125).

Once the debug code has been transferred into the onboard data memory as illustrated in FIG. 12, the location of the beginning of blocks 4 and 5 of the onboard data memory when they are addressed as program memory is stored in the test trap vector 1060, as shown in FIG. 13, and the microcontroller 100 is reset. The RESET vector causes the debug code stored in banks 4 and 5 (the boot memory 125) to be executed.

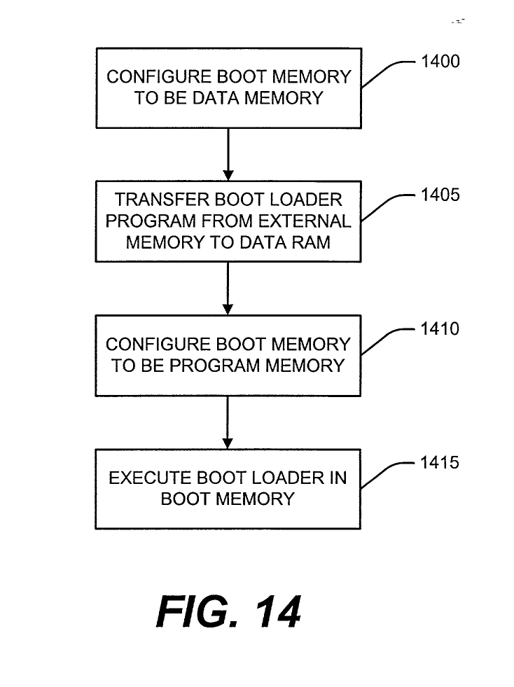

The procedure for using the boot memory to execute a program, for example to modify external memory, is illustrated in FIG. 14. First, the boot memory is configured to be data memory (block 1400). The bootloader program is then transferred from external memory to the data RAM (block 1405). The boot memory is then configured to be program memory (block 1410) and the bootloader in boot memory is executed (block 1415). Alternatively, the RESET vector could be set to point at the boot memory and the microcontroller could be reset, which would cause the bootloader in boot memory to be executed.

An advantage of the present invention is that a ROMless device, such as the microcontroller shown in FIG. 1, can provide the ability to adaptively modify external memory without a customized onboard ROM.

Another advantage of the present invention is that the boot memory 125 in the microcontroller 100 can be loaded quickly using instructions stored in external memory.

Another advantage of the present invention is that the same physical memory, the boot memory 125, serves as both data memory and program memory. This avoids wasting onboard memory space as a program memory when it is not being used as such.

Another advantage of the present invention is that the boot memory 125 can be mapped such that a write to an address normally occupied by internal program memory can take place externally, which means that the external program memory can occupy the entire available address range and all of it can be programmed using the bootloader resident in the boot memory.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A microcontroller, which addresses program memory separately from data memory, the microcontroller comprising:
a CPU;
a boot memory coupled to the CPU;
a control coupled to the CPU and to the boot memory, which
in a first state causes the boot memory to be configured as data memory; and
in a second state causes the boot memory to be configured as program memory.

2. The microcontroller of claim 1 where the control includes
a memory control register, the memory control register comprising
a program enable flag, which
when it has a first value causes the control to be in the first state; and
when it has a second value causes the control to be in the second state.

3. The microcontroller of claim 1, further comprising
an external port coupled to the CPU and to the control; where
the external port is configured as a system bus when (1) the control is in the first state, and (2) the control is in the second state and the CPU is accessing an external memory as data memory; and
the external port is configured as an input/output port when the control is in the second state and the CPU is not accessing the external memory as program or data memory.

4. The microcontroller of claim 1, further comprising
an external port coupled to the control; where
the external port is configured as a system bus when the boot memory is addressed as data memory; and
the external port is configured as an input/output port when the boot memory is addressed as program memory.

5. The microcontroller of claim 1, further comprising
an external port coupled to the control; where
the external port is configured as a system bus when the boot memory is addressed as data memory and when the CPU writes to an external memory via the external port using an instruction that allows writes to program memory; and
otherwise, the external port is configured as an input/output port.

6. A microcontroller, which addresses program memory separately from data memory, the microcontroller comprising:
a control, having a first state and a second state;
a boot memory coupled to the control;
an external port coupled to the control; where
the external port is configured as a system bus when (1) the control is in the first state and the boot memory is not addressed, or (2) the control is in the second state and the external port is used to address an external memory as program or data memory; and
the external port is configured as an input/output port when the control is in the second state, the boot memory is addressed, and the external port is not used to address the external memory as data memory.

7. The microcontroller of claim 6 where
the boot memory is configured as data memory if the port control is in the first state; and
the boot memory is configured as program memory if the port control is in the second state.

8. The microcontroller of claim 6 where
the external port is configured as a system bus when the CPU writes to an external memory via the external port using an instruction that allows writes to program memory.

9. A method for loading a boot memory onboard a microcontroller, the microcontroller addressing program memory separately from data memory, the method comprising
configuring the boot memory to be addressed as data memory unless it is already configured to be addressed as data memory;
loading a program from an external program memory into the boot memory;
configuring the boot memory to be addressed as a program memory; and
executing the program in the boot memory.

10. The method of claim 9 where loading the program from the external program memory into the boot memory comprises
moving a word of the program from external program memory into a working register by directly addressing the working register; and
moving the word from the working register to a boot memory location by directly addressing the boot memory location as a register.

11. The method of claim 9 where the boot memory is divided into banks, the boot memory is addressable using offset addressing within the banks, and loading the program from the external program memory into the boot memory comprises
moving a word of the program from external program memory into a working register by directly addressing the working register; and
moving the word from the working register to the boot memory by offset addressing the boot memory.

12. The method of claim 9 where configuring the boot memory to be addressed as data memory includes
setting the state of a control flag.

13. The apparatus of claim 12 where setting the state of the control flag comprises setting a bit in a memory control register.

14. An apparatus for booting a microcontroller, which addresses program memory separately from data memory, by loading a program from an external program memory into a boot memory on the microcontroller, the apparatus comprising
a control coupled to the boot memory, which in a first state causes the microcontroller to address the boot memory as data memory, and in a second state causes the microcontroller to address the boot memory as program memory; and
a first program stored in the external program memory which causes the microcontroller to
switch the control to the first state;
transfer a second program from the external program memory to the boot memory;
switch the control to the second state; and
execute the second program in the boot memory.

15. The apparatus of claim 14 further comprising
an external port coupled to the control, which operates as a system bus when (1) the control is in the first state, or (2) the control is in the second state and the CPU is accessing the external program memory as program or data memory, and which operates as an input/output port when the control is in the second state and the CPU is not accessing the external program memory as program or data memory.

16. The apparatus of claim 15 where
the first program causes the microcontroller to transfer the second program from the external program memory to the boot memory via the external port; and
the second program causes the microcontroller to use the external port as an input/output port and as a system bus.

17. A method for using a microcontroller, which addresses program memory separately from data memory and which includes a boot memory, to debug software stored in an external memory, the method comprising
repeating the following until the debug process is complete:
loading communication software into the boot memory;
loading a bootloader into the boot memory;
executing the communication software and the bootloader;
modifying the software stored in the external memory through the communications software and the bootloader;
loading debug software into the boot memory;
executing the debug software and the communication software;
executing the software stored in the external memory; and
stopping execution of the software stored in the external memory.

18. The method of claim 17 where loading communication software into the boot memory includes
converting the boot memory so that it is addressed by the microcontroller as data memory unless the boot memory is already addressed as data memory;
loading the communication software into the boot memory; and
converting the boot memory so that it is addressed by the microcontroller as program memory.

19. A microcontroller, comprising
a CPU;
program address and data busses coupled to the CPU;
data address and data busses coupled to the CPU;
input/output busses coupled to the CPU;
an onboard RAM comprising a boot RAM;
a memory selector, coupled to the program address and data busses, the data address and data busses and the boot RAM, which can be actuated to select whether the boot RAM is addressed by the program address and data busses or the data address and data busses;
an external interface;
an output port selector, coupled to the program address and data busses, the input/output busses and the external interface, which can be actuated to select the program address and data busses or the input/output busses to couple to the external interface;
a memory control coupled to the CPU for actuating the memory selector; and
an output port control coupled to the CPU for actuating the output port selector.
